(19) United States
(12) Patent Application Publication
(10) Pub. No.: US 2011/0247515 A1
(43) Pub. Date: Oct. 13, 2011

(54) PRINTING PROCESS

(76) Inventor: Graham Hawkins, London (GB)

(21) Appl. No.: 13/120,233

(22) PCT Filed: Sep. 22, 2008
(86) PCT No.: PCT/GB2008/003213

§ 371 Date: Jul. 5, 2011

(51) Int. Cl. B41F 33/00

(52) U.S. Cl. 101/483

(57) ABSTRACT

The invention provides a process for use in printing branding, the process comprising the steps of: a. identifying the colours used in the branding b. specifying the required colours, and c. determining the minimum number of colours which can be used to form a palette of colours which can be mixed to obtain the required colours to within a specified tolerance. The process leads to the creation of a tailored and limited colour palette.

The invention relates to a printing process, particularly a process for use in printing branding such as branded packaging.

Standard printing (eg, commercial and magazine printing) uses four standard printing inks called ‘process colours’. These process colours are cyan, magenta, yellow and black, and they are mixed to produce the standard ‘process’ range of colours.

‘Spot colours’ are non-process colours, that is, stand-alone colours used in addition to the four standard process inks. They are normally specified in colour systems such as the Pantone system, which consists of 1,114 predetermined selectable colours. However, sometimes a spot colour may be specifically developed on a bespoke basis.

Brand owners and designers specify ‘spot colours’ because they will best reproduce their brands on a consistent basis. Spot colours are often chosen for use as ‘brand colours’ in branding, that is, the colours which define a brand and help it to be differentiated from other brands, as they are less common than the process range of colours. However, the ink for each spot colour must be ordered separately. This means that many different printing inks are often required when printing branding, thereby increasing costs and complexity.

It is an object of the invention to seek to reduce the costs of printing branding such as branded packaging. This is achieved by providing a process for the optimal reproduction of specific ranges of branding from a tailored and limited colour palette.

The invention provides a process for use in printing branding, the process comprising the steps of:
a. identifying the colours used in the branding
b. specifying the required colours, and
c. determining the minimum number of colours which can be used to form a palette of colours which can be mixed to obtain the required colours to within a specified tolerance

The process leads to the creation of a tailored and limited colour palette. It can be used to obtain the largest possible colour gamut to “future proof” the palette for new designs and brands.

The colours used in the branding may be identified by means of an audit. Once the colours in the branding have been identified, they may be listed in order of decreasing importance to the branding.

The colours which are allocated primary importance may be the colours which define the brand. These are called the ‘brand colours’. They are usually spot colours.

The colours which are allocated secondary importance may be the colours which are used as product or variant descriptors, that is, the text which names the brand and identifies the variety of that brand (e.g. Pretty Polly™, Natural skin tones™). These are called the ‘product and variant descriptor’ colours. They are also usually spot colours.

The colours which are allocated tertiary importance may be the colours which are used in the general text, that is the text other than the product or variant descriptors. These colours are usually spot colours.

The colours which are used in the photographic/graphical elements of the branding may be allocated either primary or secondary importance. These are called the ‘graphical colours’. They are often a combination of process and spot colours, but this is not always the case.

The step of determining the minimum number of palette colours may comprise selecting a group of possible spot colours and a group of possible process colours and testing combinations of these colours to see how closely it is possible to match the required colours to within the specified tolerance.

Priority may be given to the most important colours, by including the most important colours in the palette.

The most important spot colours will usually be brand colours. These are the colours which it is particularly important to reproduce accurately.

The most important process colours will usually be those colours which must be mixed to obtain the graphical colours identified in the branding. Some or all of the process colours are usually selected.

The step of selecting a group of possible spot colours and process colours and testing combinations of those colours may be repeated until the required colours are matched to within the specified tolerance. The results of previous tests may be taken into account to allow the colours selected to be refined.

The required colours may be altered during the step of determining the minimum number of palette colours. The required colours may be altered according to their order of importance in the list of identified colours. Thus, if necessary, one or more of the less important colours may be approximated or omitted if it seems that the inclusion of those colours will make it difficult to minimise the number of palette colours. The required colours may also be altered according to the difficulty in obtaining the colours. Thus, if necessary, one or more colours may be approximated or omitted if it is difficult to obtain, either because of the number of suppliers involved or the substrates and printing processes required. Usually, it will only become apparent that the list of required colours requires alteration once one or more groups of possible palette colours have been already tested.

The process may be applied to a range of branding, such as a range of branded packaging belonging to a particular company.

The invention will now be illustrated, by reference to the following example of the invention.

The object of the example is to accurately reproduce the existing branded packaging produced from multiple spot and process colours, out of a tailored and limited colour palette using the process of the present invention.

An audit was carried out of all the brands within a range of packaging for a particular company. This was done by reviewing the artworks across the range of brands and packaging. The colours used in each artwork were recorded, to understand both the total number of colours in use and the frequency of use of each recorded colour.

The approved colour standards for these artworks were then reviewed and the printed colours within the standards were checked against the specified colours within the artworks. The printed colours on each substrate were measured using a spectrophotometer and the values recorded. Each audited colour on the various substrates from the various print processes were measured to establish the differences, the aim being alignment of these colours where ever they appear. These recorded values were then compared against known colour values for each listed spot colour to identify the target colour in each case, and therefore each distinct (i.e. correct) colour.

The distinct colours were reviewed to establish the brand, product and variant descriptor and graphical colours, as well as the colours of the general text.

These colours were then listed in order of priority, starting with the brand colours, followed by the product and variant descriptor colours and then the colours used in the general text. The graphical colours may be prioritised with the brand colours or with the product and variant descriptor colours, depending on their importance to the branding. The brand and product and variant descriptor colours are usually spot colours, whereas the graphical colours are usually (but not always) in the process range of colours. The colours used in the general text are usually spot colours, but again this is not always the case. The complexity of producing each colour is also considered, taking into account the number of suppliers involved in reproducing the colour, and the substrates and print processes required.

Once the audit was complete, known software such as Gretag Macbeth Color Picker software was used to determine the minimum number of printing inks (‘palette colours’) which can be mixed to obtain the required colours.

Upon completion of the audit the data collected was used to identify a possible palette and the number of colours required within the palette. A provisional palette of up to 8 colours was entered into the software as La^{o}b^{o} values. The La^{o}b^{o} value for any colour can be obtained using a spectrophotometer. The palette will usually consist of 3 or 4 spot colours and 3 or 4 process colours, depending upon supply chain parameters. The spot colours were selected from the brand, product and variant descriptor and text colours which have been identified in the audit, with the most important spot colours being given priority. These will usually be brand colours. The process colours were selected based on the graphical colours which have been identified in the audit, with the most important process colours being given priority. The spot and process colours are interdependent, so the spot colours selected for the palette may vary depending on the process colours which have been selected.

The software then calculates all the colours which can be obtained by mixing the palette colours. This is called the ‘gamut’. The ‘gamut’ is the sum of all the colours that can be achieved by mixing the palette colours. The authenticity of the provisional palette was tested by calculating the gamut that could be achieved from the provisional palette, utilising press accurate proofing on substrate, and then identifying whether all of the audit colours could be produced from this calculated gamut using the spectrophotometer readings.

The software compares each of the colours listed in the audit with the gamut to see how close a match can be obtained. For each colour, the software lists the various possible combinations of palette colours, together with a Delta E value, which indicates how close each combination is to the target colour.

Using this information, the user can then select a different set of palette colours to be tested by the software. This process can be repeated until a set of palette colours is obtained which has optimised the reproduction of the audit colours, calculated by reference to the Delta E values obtained within printing capabilities. If necessary, colours of low importance and/or high difficulty can be approximated or eliminated in order to assist in the choice of the palette colours.

The system is flexible and will allow for ‘drop in’ colours to be added at a later stage. For instance this may be the addition of a printing white or a silver etc.

The palette proposal was then made to the client, identifying the key branding colours used within the palette, and illustrating the decisions made on the reproduction of all the audit colours together with the accuracy of each colour reproduction.

The important brands, designs and elements established in the audit were converted into the harmonised colour palette and proofed on substrate to demonstrate that the correct colours had been chosen and would match the existing packaging.

On approval of the colour palette, the process of ink alignment across the different substrates and print processes begins.

Each supplier received a target ink drawdown with the tonal range for each selected palette colour, on the relevant substrate. The ink recipe may exist already, however density and colorimetric specifications are supplied.

Each supplier matches the ink to the supplied target and specifications and adapts the ink recipe for their individual process.

Each ink and the tonal range from that ink is reviewed by all parties to ensure conformity to agreed specifications.

The printer's pre-press and printing machinery is reviewed and a common ‘set-up’ is agreed. This would include plate and engraving technology and agreed printing tolerances.

Printer is supplied with ‘test form’ data for use in a fingerprint trial to obtain multi-channel profiles.

The fingerprint trial is attended and the test form data is printed in the defined colour palette. All press settings, ink density and viscosity are determined and recorded, to be used in all future production.

Fingerprint data is analysed and profiles are generated.

If necessary, key designs are converted into the new colour palette using the fingerprint data for a print trial.

1. A process for use in printing branding, the process comprising the steps of:
c. identifying the colours used in the branding
d. specifying the required colours, and
e. determining the minimum number of colours which can be used to form a palette of colours which can be mixed to obtain the required colours to within a specified tolerance.

2. A process according to claim 1, wherein the identified colours are listed in order of decreasing importance to the branding.

3. A process according to claim 2, wherein the colours which are allocated primary importance are the colours which define the brand.

4. A process according to claim 3, wherein the colours which are allocated secondary importance are the colours which are used as product or variant descriptors.

5. A process according to claim 4, wherein the colours which are allocated tertiary importance are the colours which are used in the general text.

6. A process according to claim 5, wherein the colours which are used in the photographic and graphical elements of the branding are allocated either primary or secondary importance.

7. A process according to claim 1, wherein the step of determining the minimum number of palette colours comprises selecting a group of possible spot colours and a group of possible process colours and testing combinations of those colours to see how closely it is possible to match the required colours to within the specified tolerance.

8. A process according to claim 7, wherein the spot colours are selected from the spot colours which have been identified in the branding.

9. A process according to claim 8, wherein priority is given to the most important spot colours.

10. A process according to claim 7, wherein the process colours are selected from the process colours which must be mixed to obtain the graphical colours identified in the branding.

11. A process according to claim 10, wherein priority is given to the most important graphical colours.

12. A process according to claim 7, wherein the spot colours selected are altered to take into account the process colours which have been selected.

13. A process according to claim 7, wherein the step of selecting a group of spot colours and process colours and testing combinations of those colours is repeated.

14. A process according to claim 1, wherein the required colours are altered during the step of determining the minimum number of palette colours.

15. A process according to claim 1, wherein the required colours are altered according to their order of importance, or the difficulty in obtaining the colours.

16. A process according to claim 1, wherein the process is applied to a range of branding.
